(19) United States
(12) Patent Application Publication
(10) Pub. No.: US 2017/0251031 A1
(43) Pub. Date: Aug. 31, 2017

(54) Mute Call Detection in a Communication Network System

(71) Applicant: Nokia Solutions and Networks Oy, Espoo (FI)

(72) Inventors: Sami Tapani LEHESAARI, Helsinki (FI); Petr HRUSKA, Sestajovice (CZ); Antti Sakari LEHTI, Helsinki (FI)

(21) Appl. No.: 15/512,994

(22) PCT Filed: Sep. 22, 2014
(86) PCT No.: PCT/EP2014/070122

§ 371 Date: Mar. 21, 2017

(51) Int. Cl. H04L 29/06; H04L 12/26

(52) U.S. Cl. CPC H04L 65/1083; H04L 65/80; H04L 65/1006; H04L 43/08

(57) ABSTRACT

Information on a connection status between a user equipment which accesses a core network of a communication net work system via a radio access network of the communication network system, and the core network is acquired (S21). From the information on the connection status it is determined (S22) whether or not data packets should be communicated between the user equipment and the core network. In case it is determined that data packets should be communicated, it is detected (S23) whether or not data packets are present on a user plane path between the user equipment and the core network. In case it is detected that data packets are not present on the user plane path, a silence report is generated and information on the detection result is indicated in the silence report (S24). Based on the silence report, a mute call between the user equipment and the core network is detected (S25).

### BACKGROUND OF THE INVENTION

Field of the invention

The present invention relates to communication networks, and in particular to a mute call detection in a communication network system.

Related background Art

The following meanings for the abbreviations used in this specification apply:
2G second generation
3G third generation
AMR adaptive multi rate
BSC base station controller
BTS base transceiver station
CS circuit switched
DL downlink
DTX dual transmission
ERAB evolved radio access bearer
HD high definition
IMSI international mobile subscriber identity
IPsec internet protocol security
ISHO inter system handover
L layer
LTE long term evolution
MAC media access control
MME mobility management entity
NAS non-access stratum
P-CSCF proxy call session control function
PSTN public switched telephone network
QCI quality class indicator
RAN radio access network
RF radio frequency
RLC radio link control
RNC radio network controller
RRC radio resource control
SID silence insertion descriptor
SIM subscriber identity module
TMSI temporary mobile subscriber identity
UE user equipment
UL uplink
WB wideband

When a customer of a telecom operator complains that he/she has experienced a muted call, i.e. no audio is heard, and radio network is suspected, it is usually very difficult and time consuming to find out the root cause.

According to a conventional approach, drive testing and reproducing the problem are required.

A typical process flow for finding muted calls according to the conventional approach comprises the following:
1. Determine an area and type of call (2G-3G, PSTN-3G, LTE-3G, 3G-3G etc.) required to reproduce the problem. This information can with limited reliability only be captured from customer complaints.
2. Start user plane monitoring in network element by person 1.
3. Start control plane monitoring in network element by person 1.
4. Start drive tests in the determined area, by person 2 using a known IMSI/TMSI: have second phone call open to person 1.
5. When problem has been reproduced, person 2 informs person 1 via the second phone that the problem is reproduced.
6. Person 1 immediately stops user and control plane monitoring.
7. Investigate captured logs: find the control plane and user plane data of the last voice call made by the mobile phone using the known IMSI/TMSI.

The above approach can be costly and time consuming.

### SUMMARY OF THE INVENTION

The invention aims at solving the above problems. For example, it is aimed to reduce the need to perform drive testing.

This is at least in part achieved by the method, apparatus and computer program product as defined in the appended claims.

According to a first aspect of the invention, a method for use by an apparatus is provided, comprising:
acquiring information on a connection status between a user equipment and a core network of a communication network system, the user equipment accessing the core network via a radio access network of the communication network system;
determining, from the information on the connection status, whether or not data packets should be communicated between the user equipment and the core network;
in case it is determined that data packets should be communicated, detecting whether or not data packets are present on a user plane path between the user equipment and the core network;
in case it is detected that data packets are not present on the user plane path, generating a silence report and indicating information on the detection result in the silence report; and
detecting, based on the silence report, a mute call between the user equipment and the core network.

The information on the connection status may be acquired from non-access stratum (NAS) messages and/or SIP signaling messages communicated between the user equipment and the core network.

According to an embodiment of the invention, in case the method is for use by an apparatus of the radio access network, the method may further comprise intercepting the NAS messages and/or SIP signaling messages.

According to another embodiment of the invention, in case the method is for use by an apparatus of the radio access network, the method may further comprise detecting initial voice traffic on a radio access bearer between the user equipment and the radio access network, monitoring radio access bearer for voice traffic, and acquiring the information on the connection status based on whether or not voice traffic is present on the radio access bearer.

The data packets may comprise voice data packets and/or silence indicator data packets.

The detecting whether or not data packets are present on the user plane path may comprise calculating a time period between two consecutive data packets occurring on the user plane path, and determining that data packets are not present on the user plane path in case the calculated time period exceeds a predetermined threshold.

The method may further comprise determining that there is a mute call in an uplink direction in case it is detected that data packets are not present on the user plane path from the user equipment to the core network, determining that there is a mute call in a downlink direction in case it is detected that data packets are not present on the user plane path from the core network to the user equipment, and/or determining that there is a possibility of a core network problem in case it is detected that only silence indicator packets are present on the user plane path from the core network to the user equipment, and/or determining that there is a possibility of a problem of the user equipment in case it is detected that only silence indicator packets are present on the user plane path from the user equipment to the core network.

The method may further comprise determining whether or not a radio related problem is present in the radio access network, and in case the radio related problem is present, discarding the silence report and/or adding it to statistics.

The acquiring of information on a connection status, the determining whether or not data packets should be communicated between the user equipment and the core network, and the determining of a mute call between the user equipment and the core network may be performed on a control plane of the apparatus, and the detecting whether or not data packets are present on the user plane path between the user equipment and the core network, and the generating of a silence report and the indicating of information on a detection result in the silence report may be performed on a user plane of the apparatus.

Further, in case it is determined by the control plane that data packets should be communicated, the method may comprise requesting the user plane to report to the control plane whether or not data packets are present on the user plane path, and providing the generated silence report from the user plane to the control plane.

The data packets may comprise circuit switched voice traffic encoded using an adaptive multi-rate or adaptive multi-rate wideband codec, or another codec that functions such that there is always traffic on the user plane path, i.e. either voice data packets or silence indicator data packets, and a detection of a lack of any packets can be used to determine that there is a mute call.

The apparatus may comprise at least one of a radio network controller, a base station, an eNodeB, a base station controller and a base transceiver station. The NAS signaling messages may comprise at least one of a connect message, connect acknowledge message, retrieve message, disconnect message, abort message, hold message, call drop message and connection release message. The SIP signaling messages may comprise at least one of a 200 (OK) message and a Bye message.

The control plane may comprise a radio resource control protocol. The user plane may comprises at least one of a media access control protocol and a radio link control protocol.

According to an embodiment of the invention, in case the method is for use by a user equipment, the method may further comprise monitoring incoming signals via a microphone of the user equipment, in case incoming signals via the microphone are present and the user equipment detects sending of silence indicator packets, which mark silence periods between the user equipment and the core network, towards the core network, detecting a failure condition of the user equipment.

The present invention is also achieved by a computer program product including a program for a processing device, comprising software code portions for performing the steps of the method as explained above when the program is run on the processing device. The computer program product may comprise a computer-readable medium on which the software code portions are stored, and/or the program may be directly loadable into an internal memory of the processing device.

According to a second aspect of the invention, an apparatus is provided, comprising:
a user plane entity; and
a control plane entity configured to acquire information on a connection status between a user equipment and a core network of a communication network system, the user equipment accessing the core network via a radio access network of the communication network system, and determine, from the information on the connection status, whether or not data packets should be communicated between the user equipment and the core network,
wherein, in case the control plane entity determines that data packets should be communicated, the user plane entity is configured to detect whether or not data packets are present on a user plane path between the user equipment and the core network,
in case the user plane entity detects that data packets are not present on the user plane path, the user plane entity is configured to generate a silence report and indicate information on the detection result in the silence report, and
wherein the control plane entity is configured to detect, based on the silence report, a mute call between the user equipment and the core network.

In case it is determined by the control plane entity that data packets should be communicated, the control plane entity is configured to request the user plane entity to report to the control plane whether or not data packets are present on the user plane path, and the user plane entity is configured to provide the generated silence report from the user plane entity to the control plane entity.

According to an implementation example, the control plane entity is configured to acquire the information on the connection status from non-access stratum (NAS) messages and/or SIP signaling messages communicated between the user equipment and the core network.

According to an embodiment of the invention, in case the apparatus comprises an apparatus of the radio access network, the control plane entity may be configured to intercept the NAS messages and/or SIP signaling messages.

According to another embodiment of the invention, in case the apparatus comprises an apparatus of the radio access network, the control plane entity may be configured to detect initial voice traffic on a radio access bearer between the user equipment and the radio access network, monitor radio access bearer for voice traffic, and acquire the information on the connection status based on whether or not voice traffic is present on the radio access bearer.

For detecting whether or not data packets are present on the user plane path, the user plane entity may be configured to calculate a time period between two consecutive data packets occurring on the user plane path, and determine that data packets are not present on the user plane path in case the calculated time period exceeds a predetermined threshold.

The control plane entity may be configured to determine that there is a mute call in an uplink direction in case the user plane entity detects that data packets are not present on the user plane path from the user equipment to the core network, determine that there is a mute call in a downlink direction in case the user plane entity detects that data packets are not present on the user plane path from the core network to the user equipment, and/or determine that there is a possibility of a core network problem in case the user plane entity detects that only silence indicator packets are present on the user plane path from the core network to the user equipment, and/or determine that there is a possibility of a problem of the user equipment in case the user plane entity detects that only silence indicator packets are present on the user plane path from the user equipment to the core network.

The control plane entity may be configured to determine whether or not a radio related problem is present in the radio access network, and in case the radio related problem is present, discard the silence report and/or add it to statistics.

According to an embodiment of the invention, in case the apparatus comprises a user equipment configured to monitor incoming signals via a microphone of the user equipment, the control plane entity, in case the user equipment detects that incoming signals via the microphone are present and the user plane entity detects sending of silence indicator packets, which mark silence periods between the user equipment and the core network, towards the core network, is configured to detect a failure condition of the user equipment.

According to an embodiment of the invention, a radio access network of a communication network system is provided with the capability of automatically recognizing mute calls and, if required, capture relevant symptom data.

According to an embodiment of the invention, information from user plane, control plane and non-access stratum (NAS) signaling are combined. NAS signaling that is usually transparent to RAN is intercepted and used. It can also be differentiated between (own, not B-subscriber) radio related silence and other problems.

According to another embodiment of the invention, other than intercepting NAS signaling, initial voice traffic on a radio access bearer is detected and then the radio access bearer is monitored for voice traffic.

An embodiment of the invention can be implemented in at least one of the following entities: an eNodeB of an LTE system, a 3G RNC product, an LTE UE, 3G UE and 2G UE, and a 2G BSC, for example.

According to an embodiment of the invention, automation for mute call detection is provided, and the need to perform drive testing is greatly reduced.

According to a further embodiment of the invention, an automatic collection of symptom data and generation of statistics of mute calls are enabled.

In the following the invention will be described by way of embodiments thereof with reference to the accompanying drawings.

### BRIEF DESCRIPTION OF THE DRAWINGS

FIG. 1 shows a schematic block diagram illustrating a configuration of control units in which examples of embodiments of the invention are implementable.

FIG. 2 shows a schematic block diagram illustration an environment in which an embodiment of the invention can be implemented.

FIG. 3 shows a schematic diagram for illustrating mute call detection according to an embodiment of the invention.

FIG. 4 shows a flowchart illustrating an example process of mute call detection according to an embodiment of the invention.

### DESCRIPTION OF THE EMBODIMENTS

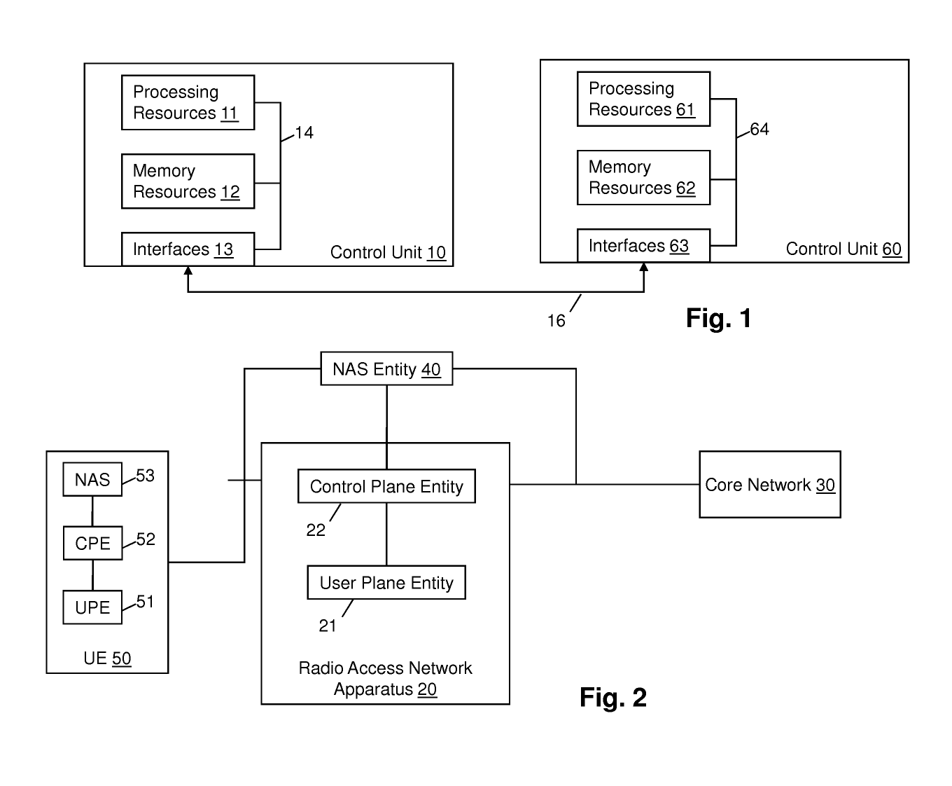

As a preliminary matter before exploring details of various implementations, reference is made to FIG. 1 for illustrating a simplified block diagram of control units 10 and 60 that are suitable for use in practicing the exemplary embodiments of this invention. According to an embodiment of the invention, the control unit 10 is used by an apparatus of a radio access network of a communication network system, such as a base station, base station controller, base transceiver station, radio network controller, NodeB, eNodeB, etc. According to an embodiment of the invention, the control unit 60 is used by a user equipment (UE).

The control unit 10 includes processing resources (processing circuitry) 11, memory resources (memory circuitry) 12 and interfaces (interface circuitry) 13 which are connected by a link 14. The interfaces 13 may include at least one interface to an NAS entity to be described later on, at least one interface to a core network of the communication network system, and at least one suitable radio frequency (RF) transceiver coupled to one or more antennas for bidirectional wireless communications over one or more wireless links 16 with user equipments.

The control unit 60 includes processing resources (processing circuitry) 61, memory resources (memory circuitry) 62 and interfaces (interface circuitry) 63 which are connected by a link 64. The interfaces 63 may include at least one suitable radio frequency (RF) transceiver coupled to one or more antennas for bidirectional wireless communications over one or more wireless links 16 with radio access networks.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory resources 12, 62 store a program assumed to include program instructions that, when executed by the processing resources, enable the electronic device to operate in accordance with the exemplary embodiments of this invention, as detailed below. Inherent in the processing resources 11, 61 is a clock to enable synchronism among the various apparatus for transmissions and receptions within the appropriate time intervals and slots required, as the scheduling grants and the granted resources/subframes are time dependent. The at least one transceiver includes both transmitter and receiver, and inherent in each is a modulator/demodulator commonly known as a modem. The processing resources 11 also are assumed to include a modem to facilitate communication over a (hardwire) link between the apparatus of the radio access network and the core network.

In general, the exemplary embodiments of this invention may be implemented by computer software stored in the memory resources and executable by the processing resources 11, 61 of the control unit 10, 60, or by hardware, or by a combination of software and/or firmware and hardware.

In general, the various embodiments of a user equipment can include, but are not limited to, mobile stations including SIM, cellular telephones including SIM, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memory resources 12, 62 may include one or more memories, may be of any type suitable to the local technical environment and may be implemented using any suitable data storage technology, such as semiconductor-based memory devices, magnetic memory devices and systems, optical memory devices and systems, fixed memory and removable memory. The processing resources 11, 61 may include one or more processors, may be of any type suitable to the local technical environment, and may include one or more of general purpose computers, special purpose computers, microprocessors, digital signal processors (DSPs) and processors based on a multi-core processor architecture, as non-limiting examples.

As mentioned above, according to an embodiment of the invention, the control unit 10 can be used by a radio access network apparatus. Additionally or alternatively, the control unit 60 can be used by a user equipment. FIG. 2 shows a schematic block diagram illustrating an environment in which a radio access network apparatus 20 according to an embodiment of the invention is implemented.

The radio access network (RAN) apparatus 20 provides access to a core network 30 for user equipments, e.g. a UE 50. The RAN apparatus 20 comprises a user plane entity 21 and a control plane entity 22. Similarly, the UE 50 comprises a user plane entity (UPE) 51, a control plane entity (CPE) 52, and an NAS layer 53.

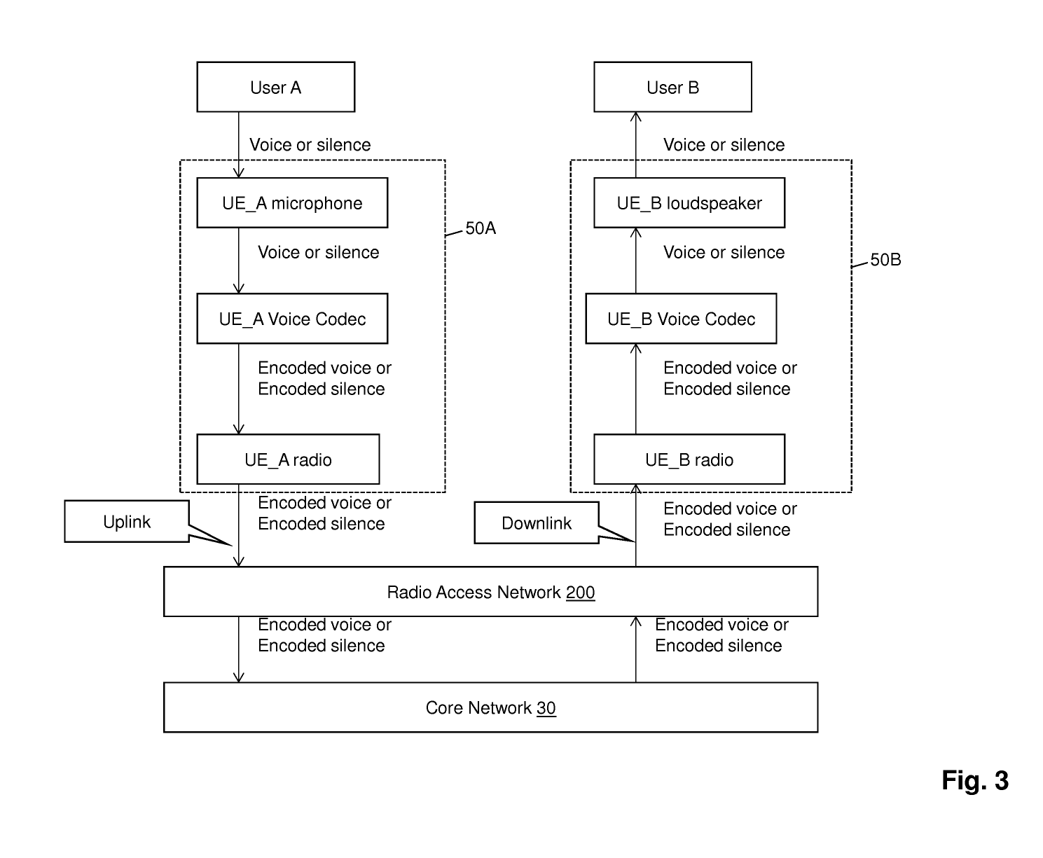

FIG. 3 illustrates a call between a user A using a user equipment 50A and a user B using a user equipment 50B. In an uplink direction of user A, a microphone of the UE 50A receives voice or silence from the user A and provides a voice codec of the UE 50A with voice or silence signals converted from the received voice or silence. The voice codec of the UE 50A codes the voice or silence signals into encoded voice or encoded silence indicator signals. At a radio interface of the UE 50A, the encoded voice or silence indicator signals are modulated into modulated encoded voice or silence indicator data packets which are transmitted to a radio access network 200. The radio access network 200 demodulates the modulated encoded voice or silence indicator data packets and sends a demodulation result to the core network 30 where the demodulation result may be processed, e.g. the encoded voice or silence indicator data packets may be decoded and re-encoded.

In a downlink direction of user B, the core network 30 sends encoded voice or silence indicator data packets to the radio access network 200, which modulates them and transmits modulated encoded voice or silence indicator data packets to the UE 50B. A radio interface of the UE 50B demodulates the modulated encoded voice or silence indicator data packets and provides a voice codec of the UE 50B with a demodulation result. The voice codec of the UE 50B decodes the demodulation result and sends voice or silence signals to a loudspeaker of the UE 50B, which then outputs voice or silence to the user B.

Referring again to FIG. 2, according to an embodiment of the invention the UE 50 comprises the UE 50A of FIG. 3. Alternatively or in addition, the UE 50 of FIG. 2 comprises the UE 50B of FIG. 3. Further, the radio access network apparatus 20 belongs to the radio access network 200.

According to an embodiment of the invention, the control plane entity 22 of the RAN apparatus 20 is configured to capture NAS signaling information from an NAS entity 40 that provides NAS signaling between the UE 50 and the core network 30. Based on the NAS signaling information, the control plane entity 22 detects a connection status of a call between the UE 50 and the core network 30, e.g. between the UE 50A and the core network 30 and/or between the UE 50B and the core network 30. In other words, the connection status is intercepted from NAS signaling. According to an implementation example of the invention, the control plane entity 22 comprises an RRC protocol.

Based on the connection status, the control plane entity 22 determines whether or not data packets including voice packets and/or silence indicator packets should be communicated between the UE 50 and the core network 30 via the user plane entity 21.

Communication of voice/silence indicator data packets starts when in the NAS signaling between the UE 50 and the core network 30 connect/connect acknowledge/retrieve messages are detected by the control plane entity 22 from the NAS signaling entity 40, and communication of voice/silence indicator data packets ends when disconnect, abort, hold, call drop or connection release messages are detected by the control plane entity 22 from the NAS signaling entity 40.

For LTE and VoIP calls, communication of voice/silence indicator packets starts with a SIP signaling message “200(0K)” between the UE 50 and the core network 30 to establish a “connect state” after “RINGING”, and communication of voice/silence indicator data packets ends with a SIP signaling message “BYE” between the UE 50 and the core network 30 to end the “connect state”. According to an embodiment of the invention, these SIP messages are detected by the control plane entity 22.

In case the control plane entity 22 determines from the intercepted NAS signaling messages that voice/silence indicator data packets should be communicated on the user plane, it requests the user plane entity 21 to report when there is no voice/silence indicator data packets on the user plane. According to an embodiment of the invention, such a control plane request is based on NAS signaling interpretation.

According to an embodiment of the invention, the fact is utilized that AMR and WB-AMR voice codecs used e.g. in LTE communication systems and 3G communication systems and to some extent in 2G communication systems always send data in both uplink and downlink during a voice call, even during silence periods in the voice call. Such “normal” silence periods are marked with special silence indicator data packets. In other words, sending either encoded voice or encoded silence indicator data packets is mandatory. If neither is received, the call is mute.

In other words, for voice calls that use an AMR codec, even if no-one is speaking, there are always data packets being sent in both uplink and downlink directions with a pre-determined interval. The data packets sent comprise either voice data silence indicators. Usually, the data packets are sent at 20 ms intervals for voice data and 160 ms for silence indicators. When there are no data packets (i.e. voice and silence indicator packets are lost) received in uplink and/or downlink for longer than this 160 ms, the voice channel is unambiguously faulty: due to radio reason, or for some other reason.

The control plane entity 22 requests the user plane entity 21 that whenever there should be AMR traffic in the user plane data (user plane path), but there is a break of data in uplink, downlink or both directions longer than a predetermined threshold, to notify this fact to the control plane entity 22 and, if required, collect symptom data of the current call. For example, the predetermined threshold comprises a value between the interval for the silence indicators plus RLC protocol window size and an L1 synchronization check timer which enables the control plane to know that L1 is not in synch.

It is to be noted that the invention is not limited to AMR but can be used with any voice encoding system with similar property. According to an implementation example of the invention, the user plane entity 21 comprises network interfaces that may additionally comprise a MAC/RLC protocol according to the 3G communication system.

In case the user plane entity 21 detects that voice/silence indicator data packets (e.g. AMR traffic) are not present on the user plane, it generates a silence report and indicates information on the detection result (e.g. symptom data) in the silence report, and provides the silence report to the control plane entity 22. Based on the silence report, the control plane entity 22 then can detect a mute call between the UE 50 and the core network 30. In other words, based on the silence report, the control plane entity 22 can detect whether the current voice call possibly is a mute call.

Further, according to an embodiment of the invention, it is possible to also differentiate between normal radio related problems and other problems: if there are L1 synchronization failures currently active from BTSs of the radio access network then this is radio related. In other words, if the L1 synchronization is lost between the UE and the radio access network at the time when silence is reported by the user plane entity, this is radio related. Also if there is a timer running for re-establishment of the radio access network, this is radio related. In such cases, the control plane entity 22 may discard the silence report from the user plane entity 21. Alternatively, the silence report may be added to statistics.

According to an embodiment of the invention, the control plane entity 22 calculates the number of mute call seconds in the radio access network for detecting radio and other problems using information included in silence reports provided by the user plane entity 21 and/or silence reports from other RAN apparatuses.

Many operators are interested in knowing how many seconds of mute calls there are in general in the network, regardless of the source of the problem. For example, with the above arrangement it is possible to recognize if a radio network parameter change causes an increase in mute call seconds, even if no other negative impact occurred.

A matter for statistics also is a case in which an encoder of the core network 30 is not working appropriately and re-encodes voice or silence indicator data packets into encoded silence indicator data packets only. According to an embodiment of the invention, the control plane entity 22 requests the user plane entity to notify if there is only silence indicators received in the downlink direction. This cannot be used to safely determine a problematic call, but can be used to make a statistical analysis: if there is a strong increase in SID silence from e.g. some particular core network transmission path, a problem in the core network 30 can be suspected.

Hence, the control plane entity 22 can perform an analysis based on the silence report received from the user plane entity 21 on a type of a current mute call symptom: is it radio related, based on a current control plane signaling status, or abnormal.

The RAN apparatus 20 can therefore be used to notify and possibly collect symptom data automatically when a mute call is detected.

According to an embodiment of the invention, the RAN apparatus 20 is an eNB of an LTE system. In this embodiment, other than intercepting NAS messages as described above, the eNB detects initial voice traffic on a radio access bearer (e.g. E-RAB) between the UE 50 and the radio access network and then monitors the radio access bearer for voice traffic. The eNB acquires the information on the connection status based on whether or not voice traffic is present on the radio access bearer.

According to an implementation example, the eNB monitors bearer (e.g. E-RAB) traffic for bearers with a voice indicator, e.g. QCI=1. The eNB starts monitoring traffic on a bearer once there has been activity on the bearer. Thus, some initial voice traffic (i.e. voice/silence indicator data packets) in uplink or downlink direction is required.

When the initial traffic is observed, the voice call is assumed to be in connected state, that is, data packets should be communicated between the UE 50 and the core network 30. Then, it is possible to differentiate between some other kind and radio related problems. Radio related problems can be detected by the eNB based on L1 synch/out of synch information, as received by eNB L3 from eNB lower layers.

Since SIP signaling may be sent over IPSec between UE and P-CSCF, the eNB cannot intercept NAS messages like in 3G and 2G. If IPSec is not used by the P-CSCF, i.e. default bearer user plane IP packets do not carry traffic with protocol IP 51=IPSec, but directly TCP, then it is possible to intercept the SIP signaling as well for a Connect OK message “200 OK”, analogously to intercepting NAS messages in 3G.

The above described implementation examples of the invention can be used for troubleshooting: problematic calls are found faster and with less effort than by using drive test methods. Further, the implementation examples can be used to quantify the problem of how many mute seconds occurred and what was the impact of the mute seconds.

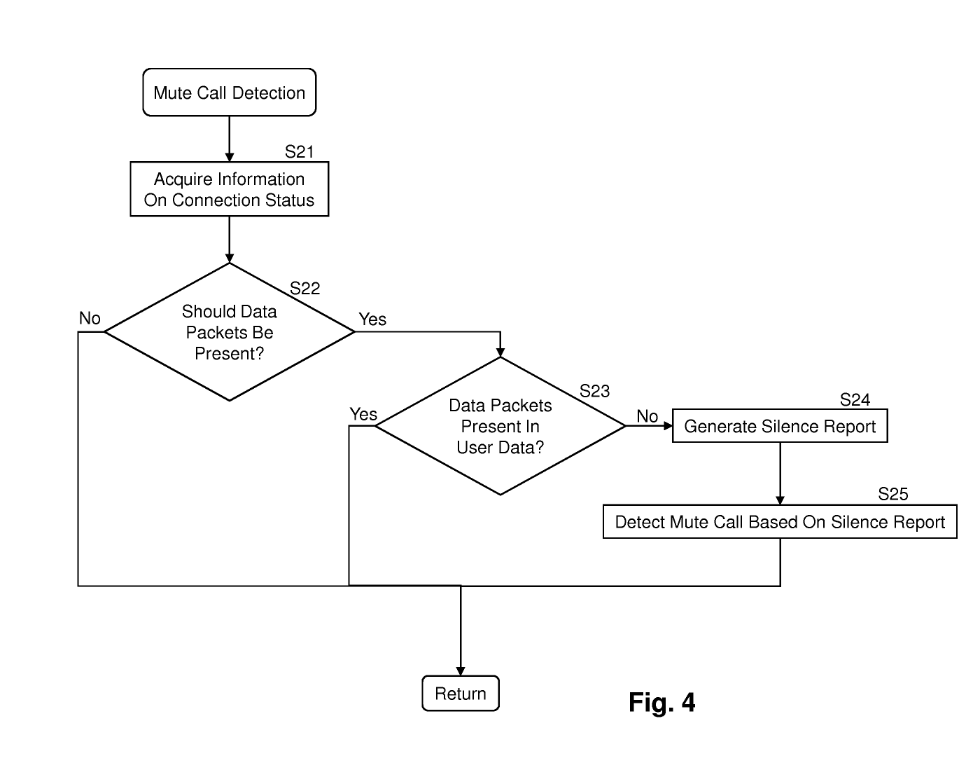

Now reference is made to FIG. 4 illustrating a flowchart of a process of mute call detection according to an embodiment of the invention. The process may be performed by the RAN apparatus 20 of FIG. 2. According to a further embodiment of the invention, the process may be performed by a user equipment such as the UE 50 of FIG. 2.

In step S21, information on a connection status of a user equipment (e.g. the UE 50 of FIG. 2) is acquired. The connection status may be acquired from non-access stratum (NAS) signaling messages between the user equipment and a core network (e.g. the core network 30 of FIG. 2) e.g. in case the RAN apparatus 20 operates according to 2G or 3G. In case the RAN apparatus 20 operates according to LTE, the connection status is acquired from voice traffic on radio access bearers as described above, or from SIP signaling messages in case IPsec is not used by a P-CSCF.

In case the process is performed by the UE 50, the connection status is derived from the NAS layer 53. For example, it is derived from SIP signaling in LTE, CS core signaling in 3G, when a call is in a “connect” status.

In step S22, it is determined, from the information on the connection status, whether or not data packets should be communicated between the user equipment and the core network.

In case it is determined in step S22 that data packets should be communicated (Yes in step S22), the process advances to step S23 in which it is detected whether or not data packets are present on a user plane path between the user equipment and the core network.

In case it is not determined in step S22 that data packets should be communicated (No in step S22), the process returns.

In step S23, a user plane entity (e.g. user plane entity 21 or 51 in FIG. 2) may detect whether or not data packets are present on the user plane path. In case it is detected in step S23 that data packets are not present on the user plane path (No in step S23), the process advances to step S24 in which a silence report is generated and information on the detection result are indicated in the silence report. According to an embodiment, a time period is calculated during which no voice traffic is occurring in the user plane data. Then, it is determined that voice traffic is not present in the user plane data in case the calculated time period exceeds a predetermined threshold. The predetermined threshold may be a value between the interval for silence indicators plus an RLC protocol window size and an L1 synchronization check timer which enables the control plane (e.g. control plane entity 22, 52 of FIG. 2) to recognize that L1 is not in synchronization.

In case it is detected in step S23 that data packets are present on the user plane path (Yes in step S23), the process returns.

In step S25, a mute call between the user equipment and the core network may be detected based on the silence report. Then, the process returns.

According to an embodiment of the invention, it is determined whether or not a radio related problem is present in the radio access network. This determination may be carried out using a control plane entity (e.g. control plane entity 22, 52 of FIG. 2). In case the radio related problem is present, the silence report generated in step S24 may be discarded or added to statistics.

In case the process of FIG. 4 is implemented in the UE 50, the UE 50 may monitor incoming signals via a microphone. In case incoming signals via the microphone are present and the UE 50 detects sending of silence indicator packets, which mark silence periods between the UE 50 and the core network 30, towards the core network 30, the UE 50 detects a failure condition.

According to an aspect of the present invention, an apparatus, such as the radio access network apparatus 20 or the UE 50 shown in FIG. 2, is provided. The apparatus comprises means for acquiring information on a connection status between a user equipment and a core network of a communication network system, the user equipment accessing the core network via a radio access network of the communication network system, means for determining, from the information on the connection status, whether or not data packets should be communicated between the user equipment and the core network, means for, in case it is determined that data packets should be communicated, detecting whether or not data packets are present on a user plane path between the user equipment and the core network, means for, in case it is detected that data packets are not present on the user plane path, generating a silence report and indicating information on the detection result in the silence report, and means for detecting, based on the silence report, a mute call between the user equipment and the core network.

The means for acquiring may acquire the information on the connection status from non-access stratum (NAS) messages and/or SIP signaling messages communicated between the user equipment and the core network.

According to an embodiment of the invention, in case the apparatus is an apparatus of the radio access network, the apparatus comprises means for intercepting the NAS messages and/or SIP signaling messages.

According to an alternative embodiment of the invention, in case the apparatus is an apparatus of the radio access network, the apparatus comprise means for detecting initial voice traffic on a radio access bearer between the user equipment and the radio access network, means for monitoring radio access bearer for voice traffic, and means for acquiring the information on the connection status based on whether or not voice traffic is present on the radio access bearer.

The data packets may comprise voice data packets and/or silence indicator data packets.

The means for detecting whether or not data packets are present on the user plane path may comprise means for calculating a time period between two consecutive data packets occurring on the user plane path, and means for determining that data packets are not present on the user plane path in case the calculated time period exceeds a predetermined threshold.

The apparatus may further comprise means for determining that there is a mute call in an uplink direction in case it is detected that data packets are not present on the user plane path from the user equipment to the core network, determining that there is a mute call in a downlink direction in case it is detected that data packets are not present on the user plane path from the core network to the user equipment, determining that there is a possibility of a core network problem in case it is detected that only silence indicator packets are present on the user plane path from the core network to the user equipment, and determining that there is a possibility of a problem of the user equipment in case it is detected that only silence indicator packets are present on the user plane path from the user equipment to the core network.

The apparatus may further comprise means for determining whether or not a radio related problem is present in the radio access network, and, in case the radio related problem is present, means for discarding the silence report and/or adding it to statistics. The radio related problem may comprise an L1 synchronization loss between the user equipment and the radio access network at the time when the silence report is generated by the user plane entity, and/or presence of a timer running for re-establishment of the radio access network at the time when the silence report is generated by the user plane entity.

The means for acquiring of information on a connection status, the means for determining whether or not data packets should be communicated between the user equipment and the core network, and the means for determining of a mute call between the user equipment and the core network operate on a control plane of the apparatus, and the means for detecting whether or not data packets are present on the user plane path between the user equipment and the core network, and the means for generating of a silence report and the means for indicating of information on a detection result in the silence report operate on a user plane of the apparatus.

The apparatus may further comprise means for, in case it is determined on the control plane that data packets should be communicated, requesting the user plane to report to the control plane whether or not data packets are present on the user plane path, and means for providing the generated silence report from the user plane to the control plane.

The data packets may comprise circuit switched voice traffic encoded using an adaptive multi-rate or adaptive multi-rate wideband codec, or another codec that functions such that there is always traffic on the user plane path, i.e. either voice data packets or silence indicator data packets, and a detection of a lack of any packets can be used to determine that there is a mute call.

The apparatus comprises at least one of a radio network controller, a base station, an eNodeB, a base station controller and a base transceiver station.

The NAS signaling messages comprise at least one of a connect message, connect acknowledge message, retrieve message, disconnect message, abort message, hold message, call drop message and connection release message.

The SIP signaling messages comprise at least one of a 200 (OK) message and a Bye message.

According to an implementation example, the control plane comprises a radio resource control protocol, and the user plane comprises at least one of a media access control protocol and a radio link control protocol.

According to an embodiment of the invention, in case the apparatus is a user equipment, the apparatus comprises means for monitoring incoming signals via a microphone of the user equipment, and means for, in case incoming signals via the microphone are present and the user equipment detects sending of silence indicator packets, which mark silence periods between the user equipment and the core network, towards the core network, detecting a failure condition of the user equipment.

The above-described means are implemented e.g. by the processing resources 11, memory resources 12 and interfaces 13 of the control unit 10, or the processing resources 61, memory resources 62 and interfaces 63 of the control unit 60.

It is to be understood that the above description is illustrative of the invention and is not to be construed as limiting the invention. Various modifications and applications may occur to those skilled in the art without departing from the true spirit and scope of the invention as defined by the appended claims.

1. A method for use by an apparatus, comprising:
acquiring information on a connection status between a user equipment and a core network of a communication network system, the user equipment accessing the core network via a radio access network of the communication network system;
determining, from the information on the connection status, whether or not data packets should be communicated between the user equipment and the core network;
in case it is determined that data packets should be communicated, detecting whether or not data packets are present on a user plane path between the user equipment and the core network;
in case it is detected that data packets are not present on the user plane path, generating a silence report and indicating information on the detection result in the silence report; and
detecting, based on the silence report, a mute call between the user equipment and the core network.

2. The method of claim 1, wherein the information on the connection status is acquired from non-access stratum (NAS) messages and/or SIP signaling messages communicated between the user equipment and the core network.

3. (canceled)

4. The method of claim 1, wherein the method is for use by an apparatus of the radio access network, the method comprising:
detecting initial voice traffic on a radio access bearer between the user equipment and the radio access network;
monitoring radio access bearer for voice traffic;
acquiring the information on the connection status based on whether or not voice traffic is present on the radio access bearer.

5. The method of claim 1, wherein the data packets comprise voice data packets and/or silence indicator data packets.

6. The method of claim 1, wherein the detecting whether or not data packets are present on the user plane path comprises:
calculating a time period between two consecutive data packets occurring on the user plane path; and
determining that data packets are not present on the user plane path in case the calculated time period exceeds a predetermined threshold.

7. The method of claim 1, comprising:
determining that there is a mute call in an uplink direction in case it is detected that data packets are not present on the user plane path from the user equipment to the core network;
determining that there is a mute call in a downlink direction in case it is detected that data packets are not present on the user plane path from the core network to the user equipment; and/or
determining that there is a possibility of a core network problem in case it is detected that only silence indicator packets are present on the user plane path from the core network to the user equipment; and/or
determining that there is a possibility of a problem of the user equipment in case it is detected that only silence indicator packets are present on the user plane path from the user equipment to the core network.

8. The method of claim 1, comprising:
determining whether or not a radio related problem is present in the radio access network; and
in case the radio related problem is present, discarding the silence report and/or adding it to statistics.

9. The method of claim 1, wherein
the acquiring of information on a connection status, the determining whether or not data packets should be communicated between the user equipment and the core network, and the determining of a mute call between the user equipment and the core network is performed on a control plane of the apparatus, and
the detecting whether or not data packets are present on the user plane path between the user equipment and the core network, and the generating of a silence report and the indicating of information on a detection result in the silence report is performed on a user plane of the apparatus.

10. (canceled)

11. The method of claim 1, wherein
the data packets comprise circuit switched voice traffic encoded using an adaptive multi-rate codec or an adaptive multi-rate wideband codec, and/or the apparatus comprises at least one of a radio network controller, a base station, an eNodeB, a base station controller and a base transceiver station, and/or
the NAS signaling messages comprise at least one of a connect message, connect acknowledge message, retrieve message, disconnect message, abort message, hold message, call drop message and connection release message, and/or
the SIP signaling messages comprise at least one of a 200 (OK) message and a Bye message.

12. (canceled)

13. The method of claim 1, wherein the method is for use by a user equipment, the method comprising:
monitoring incoming signals via a microphone of the user equipment;
in case incoming signals via the microphone are present and the user equipment detects sending of silence indicator packets, which mark silence periods between the user equipment and the core network, towards the core network, detecting a failure condition of the user equipment.

14. A computer program product comprising a non-transitory computer-readable medium including a program for a processing device, comprising software code portions for causing the processing device, when the program is run on the processing device, to perform operations comprising:
acquiring information on a connection status between a user equipment and a core network of a communication network system, the user equipment accessing the core network via a radio access network of the communication network system;
determining, from the information on the connection status, whether or not data packets should be communicated between the user equipment and the core network;
in case it is determined that data packets should be communicated, detecting whether or not data packets are present on a user plane path between the user equipment and the core network;
in case it is detected that data packets are not present on the user plane path, generating a silence report and indicating information on the detection result in the silence report; and
detecting, based on the silence report, a mute call between the user equipment and the core network.

15. (canceled)

16. An apparatus, comprising:
a memory comprising program instructions;
a processor, wherein the memory and the program instructions are configured with the processor to cause the apparatus to create and configure a user plane entity and a control plane entity;
wherein the control plane entity is configured to acquire information on a connection status between a user equipment and a core network of a communication network system, the user equipment accessing the core network via a radio access network of the communication network system, and determine, from the information on the connection status, whether or not data packets should be communicated between the user equipment and the core network,
wherein, in case the control plane entity determines that data packets should be communicated, the user plane entity is configured to detect whether or not data packets are present on a user plane path between the user equipment and the core network,
in case the user plane entity detects that data packets are not present on the user plane path, the user plane entity is configured to generate a silence report and indicate information on the detection result in the silence report, and wherein the control plane entity is configured to detect, based on the silence report, a mute call between the user equipment and the core network.

17. The apparatus of claim 16, wherein
in case it is determined by the control plane entity that data packets should be communicated, the control plane entity is configured to request the user plane entity to report to the control plane whether or not data packets are present on the user plane path, and
the user plane entity is configured to provide the generated silence report from the user plane entity to the control plane entity.

18. The apparatus of claim 16, wherein the apparatus comprises an apparatus of the radio access network, and wherein the control plane entity is configured to intercept non-access stratum (NAS) messages and/or SIP signaling messages communicated between the user equipment and the core network and to acquire the information on the connection status from the NAS messages and/or the SIP signaling messages communicated between the user equipment and the core network.

19. (canceled)

20. The apparatus of claim 16, wherein the apparatus comprises an apparatus of the radio access network, wherein
the control plane entity is configured to detect initial voice traffic on a radio access bearer between the user equipment and the radio access network, monitor radio access bearer for voice traffic, and acquire the information on the connection status based on whether or not voice traffic is present on the radio access bearer.

21. The apparatus of claim 16, wherein, for detecting whether or not data packets are present on the user plane path, the user plane entity is configured to calculate a time period between two consecutive data packets occurring on the user plane path, and determine that data packets are not present on the user plane path in case the calculated time period exceeds a predetermined threshold.

22. The apparatus of claim 16, wherein
the control plane entity is configured to determine that there is a mute call in an uplink direction in case the user plane entity detects that data packets are not present on the user plane path from the user equipment to the core network, the control plane entity is configured to determine that there is a mute call in a downlink direction in case the user plane entity detects that data packets are not present on the user plane path from the core network to the user equipment, and/or
the control plane entity is configured to determine that there is a possibility of a core network problem in case the user plane entity detects that only silence indicator packets are present on the user plane path from the core network to the user equipment, and/or
the control plane entity is configured to determine that there is a possibility of a problem of the user equipment in case the user plane entity detects that only silence indicator packets are present on the user plane path from the user equipment to the core network.

23. The apparatus of claim 16, wherein the control plane entity is configured to determine whether or not a radio related problem is present in the radio access network, and in case the radio related problem is present, discard the silence report and/or add it to statistics.

24. The apparatus of claim 16, wherein the apparatus comprises a user equipment configured to monitor incoming signals via a microphone of the user equipment, and in case the user equipment detects that incoming signals via the microphone are present and the user plane entity detects sending of silence
indicator packets, which mark silence periods between the user equipment and the core network, towards the core network, the control plane entity is configured to detect a failure condition of the user equipment.

25. The apparatus of claim 23, wherein the radio related problem comprises an LI synchronization loss between the user equipment and the radio access network at the time when the silence report is generated by the user plane entity, and/or presence of a timer running for re-establishment of the radio access network at the time when the silence report is generated by the user plane entity.
